(19) United States
(12) Patent Application Publication
(10) Pub. No.: US 2015/0067821 A1
(43) Pub. Date: Mar. 5, 2015

(54) METHOD FOR UNLOCKING ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEN-DONG LUO, Shenzhen (CN); TSUNG-JEN CHUANG, New Taipei (TW); CHIA-HUNG CHIEN, New Taipei (TW)

(21) Appl. No.: 14/470,095

(22) Filed: Aug. 27, 2014

(30) Foreign Application Priority Data
Aug. 29, 2013 (CN) 2013103835840

(51) Int. Cl. G06F 21/31; G01C 19/02; G01P 15/00

(52) U.S. Cl. CPC G06F 21/31; G01P 15/001; G01C 19/02
USPC 726/16

(57) ABSTRACT

An electronic device includes an acceleration sensor and a rotation sensor, both being independently powered, in providing a method of unlocking when locked. An acceleration of the electronic device is detected using the acceleration sensor and a rotation angle of the electronic device is then detected using the rotation sensor. The electronic device is unlocked only if the acceleration of the electronic device exceeds the predetermined value and the electronic device is additionally rotated a predetermined angle within a predetermined time.

### CROSS-REFERENCE TO RELATED APPLICATIONS

This application claims priority to Chinese Patent Application No. 201310383584.0 filed on Aug. 29, 2013 in the China Intellectual Property Office, the contents of which are incorporated by reference herein.

### FIELD

Embodiments of the present disclosure relate to security of electronic devices.

### BACKGROUND

Various kind of unlocking methods, such as unlocking by gestures, passwords, and patterns, are applied in electronic devices such as smart phones and tablet computers.

### BRIEF DESCRIPTION OF THE DRAWINGS

Implementations of the present technology will now be described, by way of example only, with reference to the attached figures.

FIG. 1 shows a block diagram of an embodiment of an electronic device.

FIG. 2 is a flowchart of one embodiment of a method for unlocking the electronic device of FIG. 1.

FIG. 3 shows possible axes of orientation of the electronic device of FIG. 1 in three-dimensional space.

FIG. 4 shows an acceleration sensor and a rotation sensor of the electronic device electrically coupled to a power pin of a synchronous dynamic random access memory (SDRAM) of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected.

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

The present disclosure is in relation to a method for unlocking an electronic device.

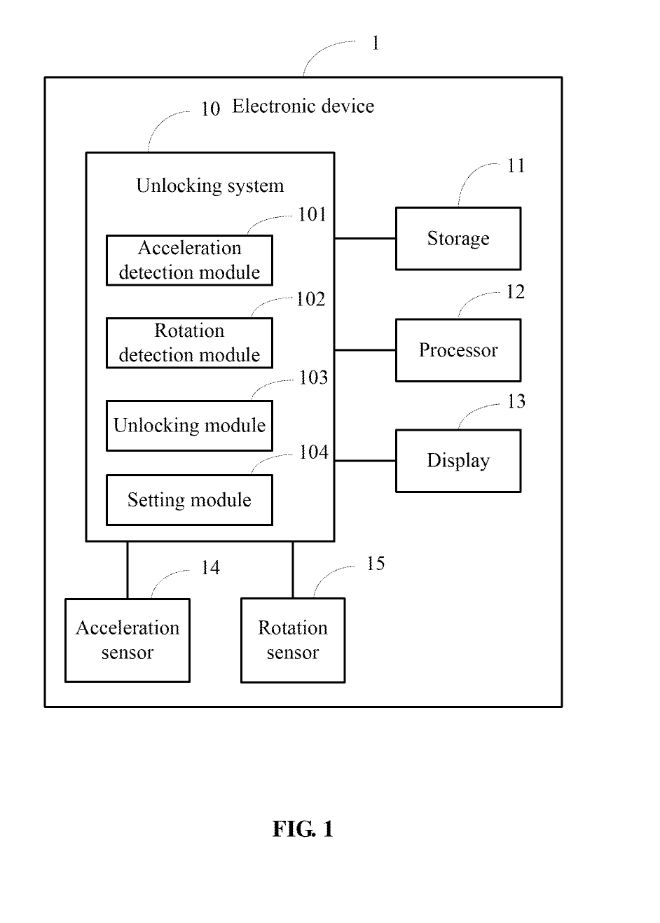

FIG. 1 illustrates a block diagram of an electronic device 1. The electronic device 1 includes an unlocking system 10, a storage 11, a processor 12, a display 13, an acceleration sensor 14, and a rotation sensor 15. In this embodiment, the electronic device 1 can be a smart phone, a mobile Internet device (MID), or a tablet computer. The electronic device 1 can include more or fewer components than those shown in the embodiment, or have a different configuration of the components.

The unlocking system 10 can include a plurality of programs in the form of one or more computerized instructions stored in the storage 11 and executed by the processor 12 to perform operations of the electronic device 1. In the embodiment, the unlocking system 10 can include an acceleration detection module 101, a rotation detection module 102, an unlocking module 103, and a setting module 104. The storage 11 can be an external or embedded non-transitory storage medium of the electronic device 1, such as a secure digital memory (SD) card, a Trans Flash (TF) card, a compact flash (CF) card, or a smart media (SM) card.

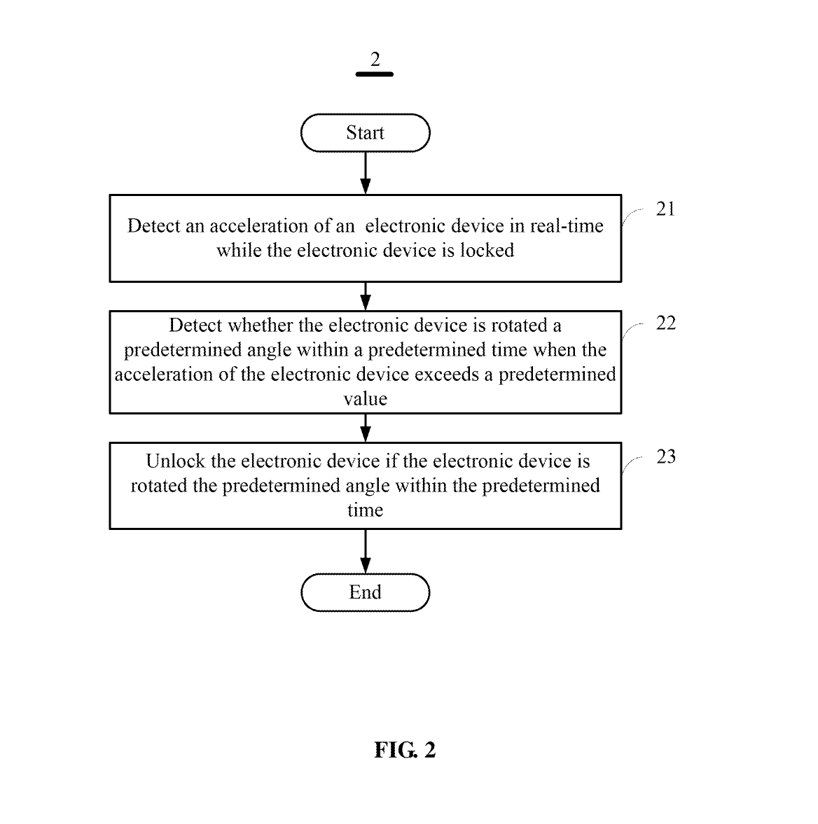

FIG. 2 illustrates a flowchart of an example method within the disclosure. The method 2 is provided by way of example, as there are a variety of ways to carry out the method. The method 2 described below can be carried out using the functional modules of the unlocking system 10 as illustrated in FIG. 2, for example, and various elements of this figure are referenced in explaining example method 2. Each block shown in FIG. 2 represents one or more processes, methods, or subroutines which are carried out in the example method 2. Furthermore, the order of blocks is illustrative only and the order of the blocks can change. Additional blocks can be added or fewer blocks may be utilized without departing from this disclosure. The example method 2 can begin at block 21.

At block 21, while the electronic device 1 is locked, the acceleration detection module 101 controls the acceleration sensor 14 to detect an acceleration of the electronic device 1 in real-time, and determines whether the sensed acceleration exceeds a predetermined value (e.g., 9.8 m/ŝ2). In this embodiment, when the electronic device 1 is locked, the electronic device 1 is in a locked state and the display 13 is turned off

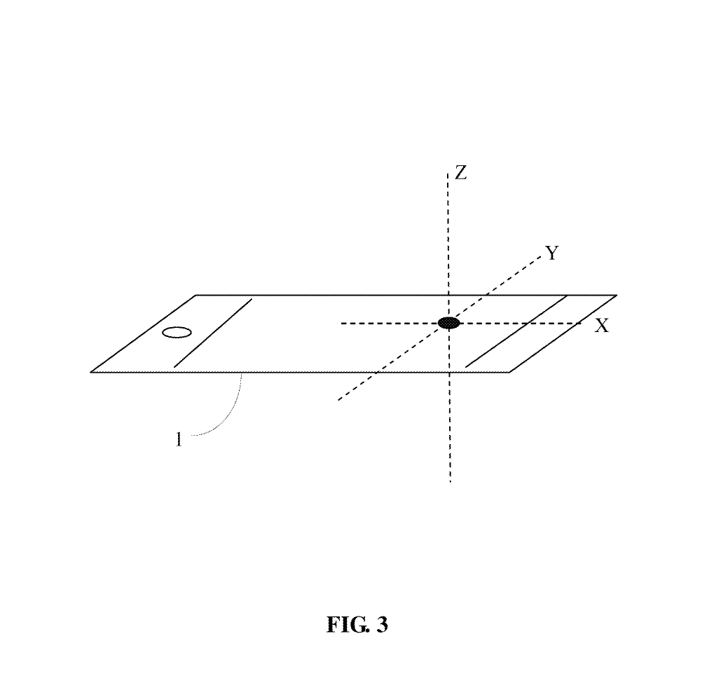

In at least one embodiment, the acceleration sensor 14 can be a G-sensor. The sensed acceleration is along a movement vector from a first orientation. The first orientation can be manually preset and stored in the storage 11. In one example, as shown in FIG. 3, a three-dimensional coordinate system having an X-axis, a Y-axis, and a Z-axis is applied to the electronic device 1 to establish its orientation. The first orientation can be along the Z-axis, or along the X-axis, or along the Y-axis.

At block 22, when the sensed acceleration of the electronic device 1 exceeds the predetermined value, the rotation detection module 102 controls the rotation sensor 15 to detect whether the electronic device 1 is rotated a predetermined angle, within a predetermined time such as one, two, or three seconds. In at least one embodiment, the predetermined angle refers to an angle of rotation of the electronic device 1 about a second orientation which can be the same as or different from the first orientation. The rotation sensor 15 can be a gyroscope.

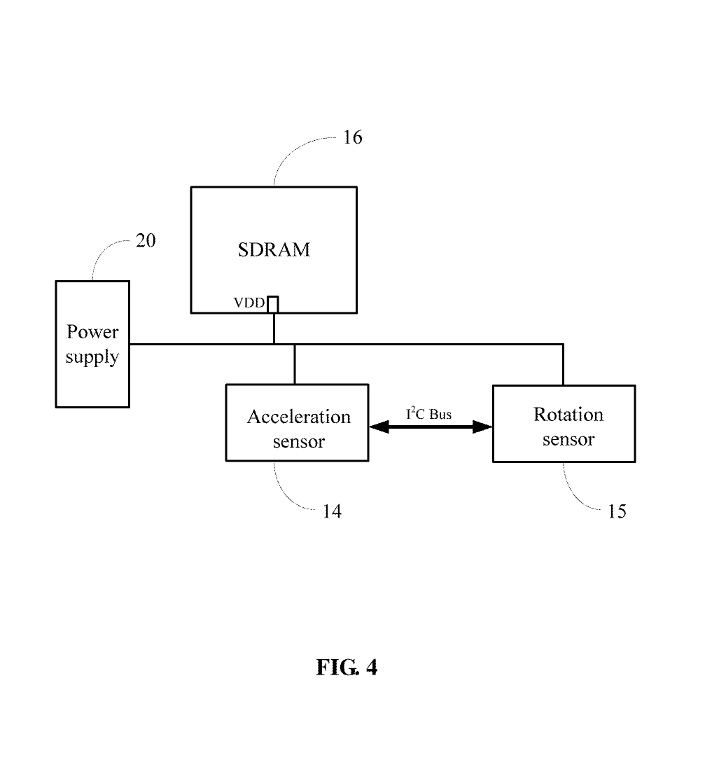

Referring to FIG. 4, in at least one embodiment, when the sensed acceleration of the electronic device 1 exceeds the predetermined value, the acceleration sensor 14 generates a trigger signal to the rotation sensor 15 to activate the rotation sensor 15 to sense any rotation angle of the electronic device 1 about the second orientation. The acceleration sensor 14 can be coupled to the rotation sensor via an inter-integrated circuit (I²C) bus to transmit the trigger signal to the rotation sensor 15. When the electronic device 1 is locked, the acceleration sensor 14 and the rotation sensor 15 continue to receive power from a power source. In one example, the electronic device 1 can further include a synchronous dynamic random access memory (SDRAM) 16 and a power supply 20 to power the SDRAM 16. The acceleration sensor 14 and the rotation sensor 15 both are electrically coupled to a voltage pin (VDD) of the SDRAM 16. The power supply 20 outputs power to the acceleration sensor 14 and the rotation sensor 15 via the VDD to power the functions of the acceleration sensor 14 and the rotation sensor 15. Since the SDRAM 16 is powered by the power supply 20 even when the electronic device 1 is locked, the acceleration sensor 14 and the rotation sensor 15 can function when the electronic device 1 is locked.

At block 23, the unlocking module 103 unlocks the electronic device 1 if the electronic device 1 is rotated the predetermined angle within the predetermined time.

In at least one embodiment, the first and second orientations, the predetermined value, and the predetermined angle can be preset and stored in the storage 11 by using the setting module 104 prior to block 21.

The unlocking method of electronic device 1 using the acceleration sensor 14 and the rotation sensor 15 to unlock the electronic device reduces unintended operations in unlocking the electronic device 1.

The embodiments shown and described above are only examples. Even though numerous characteristic and advantages of the present technology have been set forth in the foregoing description, together with details of the structure and function of the present disclosure, the disclosure is illustrative only, and changes may be made in the detail, including in particular matters of shape, size, and arrangement of the parts within the principles of the present disclosure, up to and including the full extent established by the broad general meaning of the terms used in the claims.

What is claimed is:

1. An electronic device comprising:
a processor;
an acceleration sensor coupled to the processor;
a rotation sensor coupled to the processor; and
a non-transitory storage medium storing at least one program, which when executed by the processor, causes the processor to:
detect whether an acceleration of the electronic device exceeds a predetermined value using the acceleration sensor and detect whether the electronic device is rotated a predetermined angle within a predetermined time using the rotation sensor while the electronic device is locked; and
unlock the electronic device if the acceleration of the electronic device exceeds the predetermined value and the electronic device is rotated the predetermined angle within the predetermined time.

2. The electronic device according to claim 1, wherein the acceleration of the electronic device is along a movement vector from a first orientation.

3. The electronic device according to claim 2, wherein the predetermined angle refers to an angle of rotation of the electronic device about a second orientation.

4. The electronic device according to claim 3, wherein the predetermined value, the predetermined time, the first orientation, and the second orientation are preset and stored in the non-transitory storage medium.

5. The electronic device according to claim 1, wherein the acceleration sensor is electrically coupled to the rotation sensor via an inter-integrated circuit (I²C) bus to transmit a trigger signal to the rotation sensor when the acceleration of the electronic device exceeds the predetermined value, the trigger signal activating the rotation sensor to sense any rotation angle of the electronic device about the second orientation within the predetermined time.

6. The electronic device according to claim 1, further comprising a synchronous dynamic random access memory (SDRAM) and a power supply to power the SDRAM, the acceleration sensor and the rotation sensor are electrically coupled to a voltage pin of the SDRAM, the power supply outputs power to the acceleration sensor and the rotation sensor via the voltage pin of the SDRAM to power functions of the acceleration sensor and the rotation sensor.

7. A method for unlocking an electronic device having an acceleration sensor and a rotation sensor, the method comprising:
detecting whether an acceleration of the electronic device exceeds a predetermined value using the acceleration sensor and detecting whether the electronic device is rotated a predetermined angle within a predetermined time using the rotation sensor, while the electronic device is locked; and
unlocking the electronic device if the acceleration of the electronic device exceeds the predetermined value and the electronic device is rotated the predetermined angle within the predetermined time.

8. The method according to claim 7, wherein the acceleration of the electronic device is along a movement vector from a first orientation.

9. The method according to claim 8, wherein the predetermined angle refers to an angle of rotation of the electronic device about a second orientation.

10. The method according to claim 9, wherein the predetermined value, the predetermined time, the first orientation, and the second orientation are preset and stored in the non-transitory storage medium.

11. The method according to claim 9, wherein the acceleration sensor is electrically coupled to the rotation sensor via an inter-integrated circuit (I²C) bus to transmit a trigger signal to the rotation sensor when the acceleration of the electronic device exceeds the predetermined value, the trigger signal activating the rotation sensor to sense any rotation angle of the electronic device about the second orientation within the predetermined time.

12. The method according to claim 7, wherein the electronic device comprises a synchronous dynamic random access memory (SDRAM) and a power supply to power the SDRAM, the acceleration sensor and the rotation sensor are electrically coupled to a voltage pin of the SDRAM, the power supply outputs power to the acceleration sensor and the rotation sensor via the voltage pin of the SDRAM to power functions of the acceleration sensor and the rotation sensor.
